(19) United States
(12) Patent Application Publication
(10) Pub. No.: US 2013/0139900 A1
(43) Pub. Date: Jun. 6, 2013

(54) Power Assisted Manual Valve System

(71) Applicant: Caspar Lewis, Perth (AU)

(72) Inventor: Caspar Lewis, Perth (AU)

(73) Assignee: Vetco Gray Inc., Houston, TX (US)

(21) Appl. No.: 13/312,416

(22) Filed: Dec. 6, 2011

(51) Int. Cl. F16K 31/12

(52) U.S. Cl. 137/15.01; 251/58

(57) ABSTRACT

A gate valve includes a gate and a drive train. The drive train includes a gate rod for linearly moving the gate, a translator operatively coupled to the gate rod for moving the gate rod linearly in response to rotational motion, and a coupling device connected to the translator for providing rotational motion. The gate valve also includes a fluid cylinder cooperatively coupled to the drive train for providing an assisting force to move the gate rod linearly and a rotary valve cooperatively connected to the coupling device and in a fluid flow path between the cylinder and a fluid pressure source. Torque applied to the coupling device moves the rotary valve to an open position to supply fluid pressure to the fluid cylinder.

### BACKGROUND

1. Field of the Invention

This invention relates in general to valves, and in particular to valves with power assisted opening and closing.

2. Description of the Prior Art

It is often required that surface valves are manually operated. Significant forces may be needed to open and close gate valves, due to high friction as a result of differential pressure across the gate. Large gate valves used in the oil and gas industry in surface test trees and surface trees often require the use of handwheels and gearboxes to reduce the torque needed to manually open the valve. Alternatively remotely operated vehicles (ROVs) with torque tools may be used to open and close the valves. It would be advantageous to be able to open and close such valves by hand without using excessive force and with a minimal number of turns.

Current practice is to install a valve with a fine pitch thread and a gearbox, if it is required that the valve be able to be opened and closed with minimal force exerted. However, this option would still require a great deal of strength, a large number of turns of the hand wheel and limits to the size, operating capacity and conditions of the valve.

### SUMMARY

Embodiments of this application use power assisted steering technology with a rack and rotary valve to assist the opening and closing of a valve, for example, for a gate valve in a surface tree. The output from the rotary valve rotates a valve stem and coupling.

In an embodiment of the current application, a gate valve includes a gate and a drive train. The drive train includes a gate rod for linearly moving the gate, a translator operatively coupled to the gate rod for moving the gate rod linearly in response to rotational motion, and a coupling device connected to the translator for providing rotational motion. The gate valve also includes a fluid cylinder cooperatively coupled to the drive train for providing an assisting force to move the gate rod linearly and a rotary valve cooperatively connected to the coupling device and in a fluid flow path between the cylinder and a fluid pressure source. Torque applied to the coupling device moves the rotary valve to an open position to supply fluid pressure to the fluid cylinder.

In alternative embodiments, the coupling device includes input and output couplings that are rotationally moveable relative to each other a fractional amount so that the rotation relative to each other causes the rotary valve to move to the open command position. A torsion bar may be disposed between the input coupling and the output coupling to prevent rotational movement between the input coupling and the output coupling until sufficient torque is applied to the input coupling to cause deformation of the torsion bar. The gate valve may include drive dogs mechanically connected between the input coupling and the output coupling that cause rotation in unison after the fractional amount has been reached.

The translator may include a nut rod with external threads on an outer surface, a tubular drive with an internal bore, and a travel nut retained within the internal bore of the tubular drive, the travel nut comprising internal threads which engage the external threads of the nut rod, so that rotation of the coupling device causes axial movement of the gate rod.

The cylinder may have an internal cavity comprising a nut end compartment and a gate end compartment. In some embodiments, the gate valve further includes a piston located within the cylinder, the piston separating the nut end compartment from the gate end compartment, so that a pressure differential between the nut end compartment and the gate end compartment will encourage the gate to move between the open and a closed position. An open port may be located in a side wall of the nut end compartment for supplying hydraulic fluid to and from the nut end compartment of the cylinder. A close port may be located in a side wall of the gate end compartment of the cylinder for supplying hydraulic fluid to and from the gate end compartment of the cylinder.

In other embodiments, the gate valve may include a sleeve with a central bore, a cylindrical inner member rotatable within the sleeve to a fractional amount, an open port and a close port in the sleeve spaced circumferentially apart, a supply void on the inner member extending circumferentially and an input port in the sleeve between the open and close ports to supply hydraulic fluid to the supply void. Rotation of the inner member relative to the sleeve in the first direction provides unequal communication between the open and close ports and the supply void. The circumferential extension of the supply void may be less than the circumferential distance between the open and close ports. Rotation of the inner member relative to the sleeve to the fractional amount in the first direction may block fluid communication between the close port and the supply void and provides fluid communication between the open port and the supply void. There may be a return port on the sleeve and a return void extending circumferentially on the inner member in fluid communication with the return port. Rotation of the inner member relative to the sleeve in the first direction blocks fluid communication between the open port and the return void and provides fluid communication between the close port and the return void.

In other embodiments of the current application, a method for assisting in the operation of a gate valve having a linearly moveable gate includes (a) coupling a piston rod of a bi-directional hydraulic cylinder to the gate; (b) connecting a rotary to linear translator to the piston rod; (c) connecting an input coupling to the translator and providing the input coupling with a rotary valve that is connected between a hydraulic fluid source and the hydraulic cylinder; and (d) rotating the input coupling in a first direction which causes the translator to move the piston rod and gate to an open position. The rotation in step (d) also causing the rotary valve to direct fluid from the source to the cylinder to create an open assisting force on the piston rod. Rotating the input coupling in a second direction may cause the translator to move the piston rod and gate to a closed position and the rotary valve to direct fluid from the source to the cylinder to create a close assisting force on the piston rod.

The rotary valve may have open command ports and close command ports, and the step of rotating the input coupling in a first direction may communicate the open command port with the source and restrict the close command ports from the source. The assisting force provided by the cylinder may be proportional to an amount of torque imposed on the input coupling.

The input coupling may have an input portion and an output portion and step (d) initially causes the input portion to rotate a fractional amount relative to the output portion. The fractional amount of relative rotation may cause rotation of one component of the rotary valve relative to another component of the valve. After reaching the fractional amount, continued rotation of the input coupling may cause the input portion and output portion to rotate in unison.

### BRIEF DESCRIPTION OF THE DRAWINGS

So that the manner in which the above-recited features, aspects and advantages of the invention, as well as others that will become apparent, are attained and can be understood in detail, a more particular description of the invention briefly summarized above may be had by reference to the embodiments thereof that are illustrated in the drawings that form a part of this specification. It is to be noted, however, that the appended drawings illustrate only preferred embodiments of the invention and are, therefore, not to be considered limiting of the invention's scope, for the invention may admit to other equally effective embodiments.

FIG. 1 is a sectional view of a power assisted system of an embodiment of the current application.

FIG. 2A is a sectional view of a drive nut assembly portion of the power assisted system of FIG. 1.

FIG. 2B is a cross sectional view of a travel nut of the power assisted system of FIG. 2A taken along the line 2B-2B of FIG. 2A.

FIG. 3A is a sectional view of a valve drive system of the power assisted system of FIG. 1.

FIG. 3B is a partial sectional view of a dog and dog recess of the power assisted system of FIG. 3A taken along the line 3B-3B of FIG. 3A.

FIG. 3C is a cross sectional view of the valve drive system of the power assisted system of FIG. 3A in a neutral position, taken along line 3C-3C of FIG. 3A.

FIG. 3D is a cross sectional view of the valve drive system of the power assisted system of FIG. 3A similar to FIG. 3C, but with the system in an open position.

FIG. 3E is a cross sectional view of the valve drive system of the power assisted system of FIG. 3A, similar to FIG. 3C, but with the system in a close position.

FIG. 4 is a schematic view of the hydraulic system of the power assisted system of FIG. 1.

### DETAILED DESCRIPTION

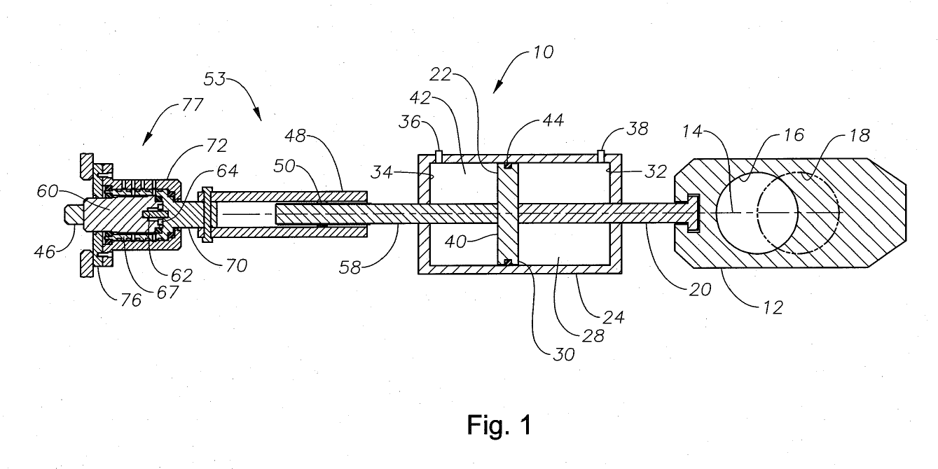

Referring to FIG. 1, a power assisted valve system 10 of an embodiment of the current application is shown to include a valve member, which may be, for example, gate 12, which moves along a central axis 14 of system 10. A gate opening 16 through gate 12 will be in fluid communication with valve bore 18 when the gate 12 is in an open position and will block the flow of fluid through valve bore 18 when gate 12 is in a closed position. In alternative embodiments, valve system 10 may instead include alternative valve types that utilize axial movement to open and close.

One end of output rod, or gate rod 20 is connected to an end of gate 12. The other end of gate rod 20 is securely fastened to a piston 22 within cylinder 24. Cylinder 24 is a tubular member with an internal cavity that contains piston 22. A piston 22 is reciprocally carried within cylinder 24, defining a chamber 28 between gate side 30 of piston 22 and gate end 32 of cylinder 24. As piston 22 moves along axes 14 of system 10 within cylinder 24, gate rod 20 also moves along axis 14 of system 10, causing gate 12 to also move along axis 14 of system 10 between open and closed positions. When piston 22 moves axially away from gate end 32 of cylinder 24 and towards nut end 34 of cylinder 24, gate 12 moves to a closed position. Conversely, when piston 22 moves axially away from nut end 34 of cylinder 24 and towards gate end 32 of cylinder 24, gate 12 moves to an open position.

A hydraulic pumping system will manage the flow of hydraulic fluids through hydraulic open port 36 and hydraulic close port 38 to create differential pressure between the nut side 40 and gate side 30 of piston 22 to urge piston 22 to move axially towards gate end 32 of cylinder 24 and gate 12 to move to an open position. This may occur, for example, by injecting hydraulic fluid into hydraulic open port 36, removing hydraulic fluid through hydraulic close port 38, or some combination thereof.

Hydraulic fluid pumped into hydraulic open port 36 is contained within a nut end compartment 42 which is defined by the interior wall of cylinder 24, the nut side 40 of piston 22 and nut end 34 of cylinder 24. Pumping hydraulic fluid into open port 36 will urge piston 22 to move axially away from nut end 34 of cylinder 24 and towards gate end 32 of cylinder 24 such that gate 12 moves towards an open position.

Hydraulic fluid pumped into hydraulic close port 38 is contained within gate end compartment 28. A ring seal 44 is located between piston 22 and the interior wall of cylinder 24, sealing nut end compartment 42 from fluid communication with gate end compartment 28. Pumping hydraulic fluid into close port 38 will cause piston 22 to move axially away form gate end 32 of cylinder 24 and towards nut end 34 of cylinder 24 such that gate 12 moves towards a closed position.

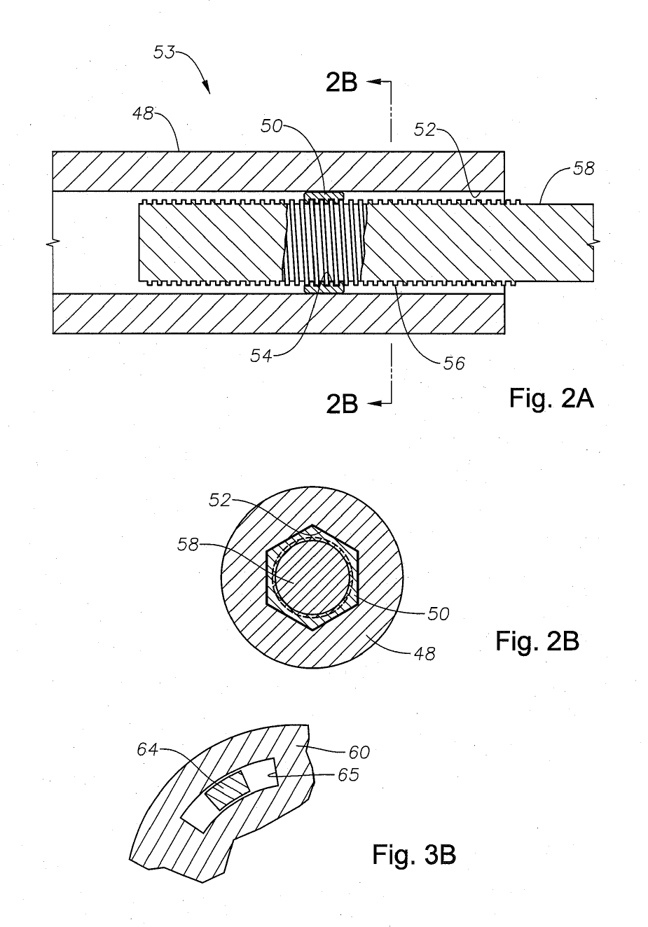

A mechanical device is used to cause piston 22 to move axially within cylinder 24, and the hydraulic system assists in the movement. The mechanical device includes a square drive 46 located at a nut end of valve system 10. Square drive 46 is a solid elongated member which may have a square, polygonal, or other geometric cross section. When square drive 46 is rotated, it causes a drive coupling 48, to rotate. Drive coupling 48 is a tubular member with a bore 52. Drive nut assembly 53, as can be seen in more detail in FIG. 2A, has a travel nut 50 secured within bore 52 of drive coupling 48. In this example, travel nut 50 is fixed within bore 52 such that it cannot move axially or rotationally relative to drive coupling 48. Internal bore 52 may be hexagonal in cross section, as can be seen in FIG. 2B. In such an embodiment, the external shape of travel nut 50 will mate with and engage the hexagonal cross section of internal bore 52 so that relative rotational movement between travel nut 50 and internal bore 52 is limited. Travel nut 50 has internal threads 54 which engage external threads 56 located on an outer surface of an input rod, or nut rod 58 in proximity to a drive end of a nut rod 58.

Returning to FIG. 1, the other end of nut rod 58 is connected to piston 22. As drive coupling 48 rotates, travel nut 50 will also rotate, but nut rod 58 does not rotate. Instead, the internal threads 54 engage external threads 56 (FIG. 2B), causing axial movement of nut rod 58, which in turn causes piston 22 to move axially within cylinder 24 (FIG. 1). Therefore, when square drive 46 is rotated, piston 22 will either move axially away from gate end 32 of cylinder 24 and towards nut end 34 of cylinder 24, causing gate 12 to move to a closed position; or conversely, piston 22 will move axially away from nut end 34 of cylinder 24 and towards gate end 32 of cylinder 24, causing gate 12 to move to an open position. Drive nut assembly 53 therefore acts as a translator to convert rotary motion of square drive 46 to linear movement of gate 12.

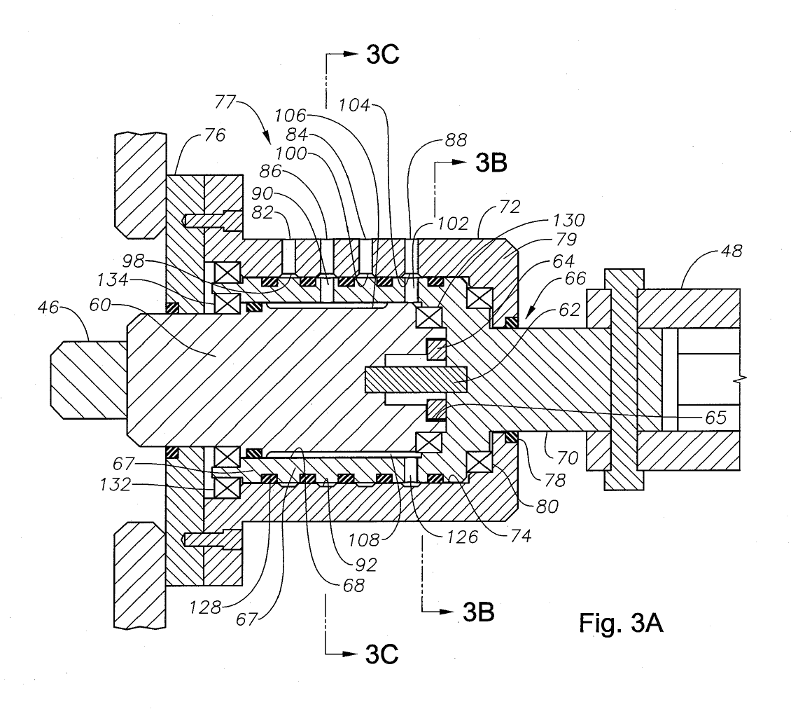

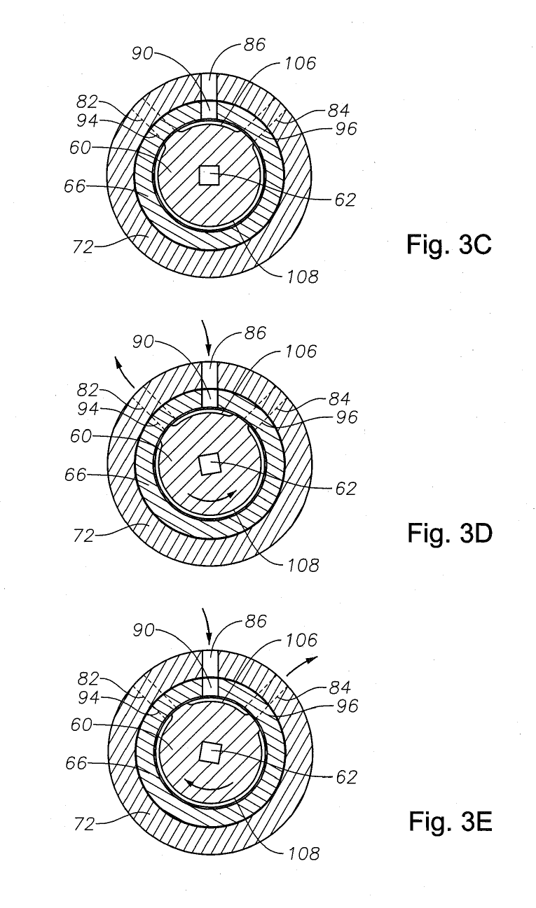

In situations where it is desirable for an operator to manually open and close gate 12, embodiments of the current application also provide a means for hydraulically assisting the operator to do so. Turning to FIG. 3A, in such an embodiment, square drive 46 may be fitted with a hand wheel. Square drive 46 is connected to a drive end of input coupling 60. The opposite end of input coupling 60 houses a torsion bar 62 and drive dogs 64. Both the torsion bar 62 and dogs 64 mate with output coupling 66. Torsion bar 62 may be a solid length of metal, elastomeric or other material with elastic properties, with a square or other geometric shaped cross section. One end of torsion bar 62 is located within a recess in an end of input coupling 60, which has a similar shaped and sized cross section to the cross section of torsion bar 62. Similarly, the other end of torsion bar 62 is located within a recess of output coupling 66 which has a similar shaped and sized cross section to the cross section of torsion bar 62.

Output coupling 66 comprises a cylindrical tubular section 67 with a bore 68 and a solid stem section 70. Input coupling 60 is located within the bore 68 of output coupling 66. Stem section 70 of output coupling 66 is secured to drive coupling 48 in a manner which prevents relative rotation movement between output coupling 66 and drive coupling 48. For example, an end of stem section 70 may be located within bore 52 of drive coupling 48 and stem section 70 may be bolted to drive coupling 48. Therefore the valve drive system 77 comprises an input coupling 60, output coupling 66, housing 72 and base plate 76.

When no forces are being applied to valve system 10 to open or close gate 12, torsion bar 62 maintains the relative rotational alignment between the input coupling 60 and the output coupling 66. As square drive 46 is rotated, input coupling 60 rotates. If sufficient force is applied to input coupling 60, torsion bar 62 will undergo elastic deformation and allow for relative rotational movement between input coupling 60 and output coupling 66.

Dogs 64 may be solid members that protrude from the bottom of bore 68 of output coupling 66 and engage dog recesses 65 in the end of input coupling 60. Dogs may be formed of metal or other suitable material. As seen in FIG. 3B, dogs 64 have sufficient clearance within recesses 65 to allow for a fractional amount of relative rotational movement between input coupling 60 and output coupling 66, but not so much clearance to allow the torsion bar 62 to shear. The fractional amount of relative rotational movement will be sufficient to generate the open and close fluid flow paths as discussed in more detail herein. When the square drive 46 is rotated, after such clearance is overcome, dogs 64 will engage an interior side wall of recess 65 and will transmit the rotation of input coupling 60 to rotation of output coupling 66, causing drive coupling 48, to rotate and gate 12 to move towards either an open or closed position.

A housing 72 surrounds the tubular section 67 of output coupling 66. Housing 72 is a generally cylindrical member with an internal cavity 74. Internal cavity 74 is open at a drive end and has a closure 79 at the other end. The tubular section 67 of output coupling 66 is located within internal cavity 74. The open drive end of housing 72 is secured to a base plate 76, which is stationary. For example, housing 72 may be bolted to base plate 76. Closure 79 has an opening through which the stem 70 of output coupling 66 protrudes. Bottom seal 78 is disposed between output coupling 66 and housing 72, sealingly engaging both the output coupling 66 and housing 72, creating a seal between output coupling 66 and housing 72. Cylindrical bearing element 80 maintains a coaxial relationship between output coupling 66 and housing 72.

Housing 72 includes ports 82, 84, 86, 88 which pass though a side wall of housing 72. The valve drive system 77 includes a supply hydraulic fluid flow path. Housing supply port 86 is axially aligned with output supply port 90, which passes through a side wall of the tubular section 67 of output coupling 66. If housing supply port 86 is not rotationally aligned with output supply port 90, an annular supply or gallery groove 92 within internal cavity 74 of housing 72 will allow for fluid communication between housing supply port 86 and output supply port 90. Supply groove 92 has a width that is substantially similar to that of the diameter of both housing supply port 86 and output supply port 90 (FIG. 3A). Ports 82, 84 are spaced apart from each other along the axis of output coupling 66, as shown in FIG. 3A. Although illustrated in FIG. 3C as being at different circumferential locations relative to housing supply port 86, ports 82, 84 may be axially aligned with housing supply port 86.

As shown in FIG. 3C, housing open port 82 and housing close port 84 optionally may be aligned with an output open port 94 and output close port 96, respectively, extending through the side wall of output coupling 66. Output open port 94 and output close port 96 are spaced circumferentially apart from each other, such as about 80°. If housing open port 82 is not rotationally aligned with output open port 94, an annular open gallery groove 98 within internal cavity 74 of housing 72 will allow for fluid communication between housing open port 82 and output open port 94. Open groove 98 has a width that is substantially similar to that of the diameter of both housing open port 82 and output open port 94. If housing close port 84 is not rotationally aligned with output close port 96, an annular close gallery groove 100 within internal cavity 74 of housing 72 will allow for fluid communication between housing close port 84 and output close port 96. Close groove 100 has a length that is substantially similar to that of the length of both housing close port 84 and output close port 96.

The valve drive system 77 additionally includes a return hydraulic fluid flow path. Housing return port 88 is axially aligned with output return port. If housing return port 88 is not rotationally aligned with output return port 102, an annular return gallery groove 104 within internal cavity 74 of housing 72 will allow for fluid communication between housing return port 88 and output return port 102. Return groove 104 has a width that is substantially similar to that of the diameter of both housing return port 88 and output return port 102.

A supply void 106 is located on the outer surface of the input coupling 60. It is a shallow recess located axially beneath output supply port 90. As shown in FIG. 3C, the circumferentially extending width of supply void 106 is such that when no mechanical forces are being applied to valve system 10 to open or close gate 12, the supply void 106 extends to, but not beyond, a near edge of output open port 94 and output close port 96. The circumferential width of supply void 106 is approximately the circumferential distance between the edges of output open port 94 and output close port 96. The length of supply void 106 is such that it extends axially from the housing open port 82 to the housing close port 84, but does not reach the housing return port 88.

A return void 108 is located on the outer surface of the input coupling 60. It is a shallow recess located on the opposite side of input coupling 60 as supply void 106. The width of return void 108 is such that when no forces are being applied to valve system 10 to open or close gate 12, the return void 108 extends to, but not beyond a near edge of both the output open port 94 and output close port 96. The length of return void 108 is such that it extends axially from the housing open port 82 to the housing return port 88.

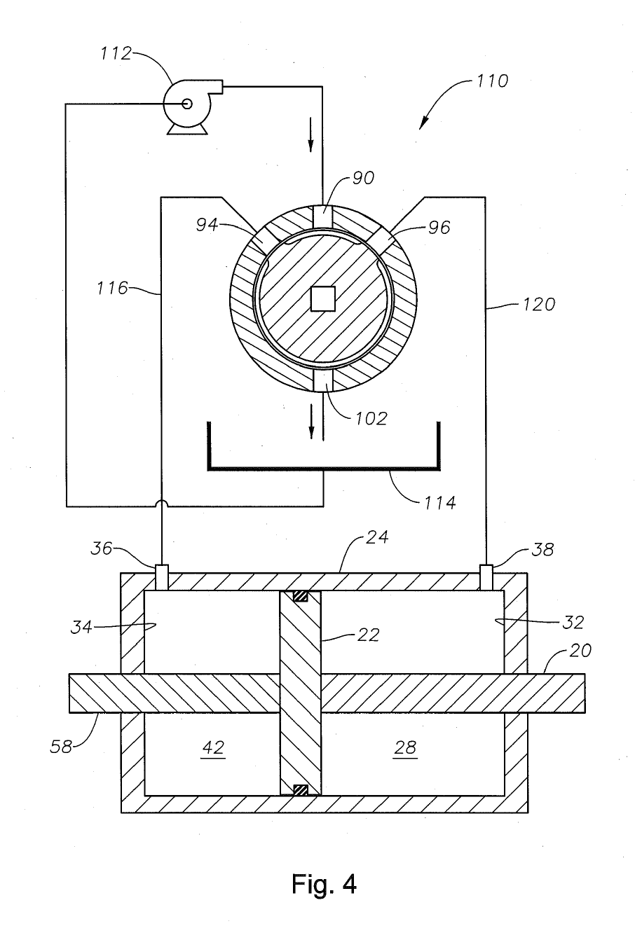

Turning now to FIG. 4, a hydraulic system 110 includes a pump 112 for supplying hydraulic fluids to output supply port 90. Hydraulic fluids can be drawn from a reservoir 114 which contains hydraulic fluids that exit through output return port 102. Open hydraulic flow line 116 fluidly connects output open port 94 and open port 36 in cylinder 24, which is in fluid communication with nut end compartment 42 of cylinder 24. Close hydraulic flow line 120 fluidly connects output close port 96 and close port 38, in cylinder 24, which is in fluid communication with gate end compartment 28 of cylinder 24. Returning to FIG. 3A, a secondary return port 126 is in fluid communication with return void 108. Secondary return port 126 extends through an opposite side wall of the tubular section 67 of output coupling 66 than output return port 102 and is axially aligned with output return port 102.

In operation, when no rotational forces are being applied to valve system 10 to open or close gate 12, hydraulic fluid traveling into housing supply port 86 (FIG. 3A) will flow through output supply port 90, either directly, if supply ports 86, 90 are rotationally aligned, or by way of annular supply groove 92 if they are not. As seen in FIG. 3C, hydraulic fluid passing through output supply port 90 will enter supply void 106. Torsion bar 62 maintains the rotational alignment of input coupling 60 and output coupling 66 such that no hydraulic fluid enters output open or close ports 94, 96. In alternative embodiments, torsion bar 62 maintains the rotational alignment of input coupling 60 and output coupling 66 such that equal amounts of hydraulic fluid enter output open and close ports 94, 96. Therefore a supply flow path of the valve drive system 77 will include housing supply port 86, annular supply groove 92, output supply port 90, and supply void 106.

As seen in FIG. 4, the hydraulic fluid may then be contained in reservoir 114 for continued use by hydraulic system 110. Therefore a return flow path of the valve drive system 77 will include return void 108, secondary return port 126, annular return groove 104, and housing return port 88.

If an operator wishes to open or close the valve, the operator rotates square drive 46. In the embodiment of FIG. 3A, a counterclockwise rotation will open the valve and a clockwise rotation will close the valve. Torsion bar 62 will twist and allow for some relative rotational movement between input coupling 60 and output coupling 66. As input coupling 60 rotates relative to output coupling 66, supply void 106 located on output coupling 66 will rotate relative to the output open and close ports 94, 96.

Therefore, as seen in FIGS. 3A and 3D, the rotation of square drive 46 in a counterclockwise motion will cause the valve drive system 77 to move to an open command position. Counterclockwise rotation of square drive 46 will cause supply void 106 to rotate counterclockwise relative to output ports 90, 94, 96 such that supply void 106 will rotate counterclockwise relative to output coupling 66 so that the circumferential length of supply void 106 will be in fluid communication with both output supply port 90 and output open port 94 but not output close port 96. Again, hydraulic fluid is pumped by pump 112 (FIG. 4) into housing supply port 86 will travel through output supply port 90, either directly if the supply ports 86, 90 are rotationally aligned or by way of annular supply groove 92 if they are not, and reach supply void 106.

In this case, some of the hydraulic fluid in supply void 106 will travel into output open port 94 and into housing open port 82, either directly if the open ports 82, 94 are rotationally aligned, or by way of annular open groove 98. As seen in FIG. 4, hydraulic fluid will then travel through open hydraulic flow line 116 to open port 36 and enter nut end compartment 42 of cylinder 24. The extra hydraulic pressure in nut end compartment 42 of cylinder 24 will encourage piston 22 to move axially away from nut end 34 of cylinder 24 and towards gate end 32 of cylinder 24 such that gate 12 (FIG. 1) moves towards an open position. Therefore the open flow path of the valve drive system 77 will include supply void 106, output open port 94, annular open groove 98, and housing open port 82 and rotating square drive 46 can activate, or select, the open flow path of valve drive system 77.

In this manner, as an operator rotates square drive 46, the hydraulic system (FIG. 4) will assist with the opening of the valve so that the operator himself does not have to apply all of the force to square drive 46 to overcome all of the forces required to move gate 12 to an open position. In the event the hydraulic system failed, as the operator rotates square drive 46, after the clearance of the dogs 64 between input coupling 60 and output coupling 66 is overcome, dogs 64 engage the side walls of recess 65 (FIG. 3B) and will mechanically transmit the rotation of input coupling 60 to rotation of output coupling 66, causing drive coupling 48 to rotate. As seen in FIG. 2A, as drive coupling 48 rotates, travel nut 50 rotates and the internal threads 54 of travel nut 50 engage the external threads 56 of nut rod 58. This causes axial movement of nut rod 58 which in turn causes gate 12 to move to an open position.

Therefore both the continued rotation of square drive 46 and the hydraulic system 110 are working to move the gate 12 to an open position. In order for the hydraulic system 110 to provide assistance, the operator only needs to apply sufficient force to cause supply void 106 to rotate counterclockwise relative to output ports 90, 94. The greater the torque applied to square drive 46, the greater the relative rotation between void 106 and output ports 90, 94, causing more hydraulic fluid to be directed into the output open port 94 and providing more assistance to the operator e in moving gate 12 to an open position.

As piston 22 moves towards gate end 32 of cylinder 24, hydraulic fluid in gate end compartment 28 will be forced out close port 38, through close hydraulic flow line 120 and into output close port 96. Returning to FIGS. 3A and 3D, hydraulic fluid will reach output close port 96 either directly from housing close port 84, if close ports 84, 96 are rotationally aligned, or by way of annular close groove 100 if they are not. Because input coupling 60 has rotated counterclockwise relative to output coupling 66, return void 108 is now in fluid communication with output close port 96. Hydraulic fluid can therefore travel from output close port 96 and into return void 108 where it then pass though secondary return port 126 through annular return groove 104 and exit the housing 72 though housing return port 88. As seen in FIG. 4, the hydraulic fluid may then be contained in holding tank 114 for continued use by hydraulic system 110.

If the operator desires to move gate 12 towards a closed position, the operator would instead rotate square drive 46 in a clockwise motion. Looking at FIG. 3A and FIG. 3E, the rotation of square drive 46 in a clockwise motion will cause the valve drive system 77 to move to a closed command position. Rotation of square drive 46 in a clockwise motion will cause supply void 106 to rotate clockwise relative to output ports 90, 94, 96 such that supply void 106 will be in fluid communication with both output supply port 90 and output close port 96 but not output open port 94. Again, hydraulic fluid is pumped by pump 112 (FIG. 4) into housing supply port 86 will travel through output supply port 90, either directly if the supply ports 86, 90 are rotationally aligned or by way of annular supply groove 92 if they are not, and reach supply void 106.

In this case, some of the hydraulic fluid in supply void 106 will travel into output close port 96 and into housing close port 84, either directly if the close ports 84, 96 are rotationally aligned, or by way of annular close groove 100. As seen in FIG. 4, hydraulic fluid will then travel through close hydraulic flow line 120 to close port 38 and enter gate end compartment 28 of cylinder 24. The extra hydraulic pressure in gate end compartment 28 of cylinder 24 will encourage piston 22 to move axially towards nut end 34 of cylinder 24 and away from gate end 32 of cylinder 24 such that gate 12 (FIG. 1) moves towards an closed position. Therefore the close flow path of the valve drive system 77 will include supply void 106, output close port 96, annular close groove 100, and housing close port 84 and rotating square drive 46 can activate, or select, the close flow path of valve drive system 77.

In this manner, as an operator rotates square drive 46 in a clockwise motion, the hydraulic system (FIG. 4) will assist with the closing of the valve so that the operator himself does not have to apply all of the force to square drive 46 to overcome all of the forces required to move gate 12 to a closed position. Returning to FIG. 1, as the operator rotates square drive 46, after the clearance of the dogs 64 between input coupling 60 and output coupling 66 is overcome, dogs 64 will be engaged and will transmit the rotation of rotation of input coupling 60 to rotation of output coupling 66, causing drive coupling 48 to rotate. As seen in FIG. 2A, as drive coupling 48 rotates, travel nut 50 rotates and the internal threads 54 of travel nut 50 engage the external threads 56 of nut rod 58. This causes axial movement of nut rod 58 which in turn causes gate 12 to move to a closed position.

Therefore both the continued rotation of square drive 46 and the hydraulic system 110 are working to move the gate 12 to a closed position. In order for the hydraulic system 110 to provide assistance, the operator only needs to apply sufficient force to cause supply void 106 to rotate clockwise relative to output ports 90, 96 and the greater the torque applied to square drive 46, the greater the relative rotation between void 106 and output ports 90, 96, the more hydraulic fluid will be directed into the output close port 96 and the more assistance the operator will receive in moving gate 12 to a closed position.

As piston 22 moves towards nut end 34 of cylinder 24, hydraulic fluid in nut end compartment 42 will be forced out open port 36, through open hydraulic flow line 116 and into output open port 94. Returning to FIGS. 3A and 3E, hydraulic fluid will reach output open port 94 either directly from housing open port 82, if open ports 82, 94 are rotationally aligned, or by way of annular open groove 98 if they are not. Because input coupling 60 has rotated clockwise relative to output coupling 66, return void 108 is now in fluid communication with output open port 94. Hydraulic fluid can therefore travel from output open port 94 and into return void 108 where it then pass though secondary return port 126 through annular return groove 104 and exit the housing 72 though housing return port 88. As seen in FIG. 4, the hydraulic fluid may then be contained in reservoir 114 for continued use by hydraulic system 110.

In order to maintain the open, close, supply and return hydraulic flow paths fluidly separated from each other, separations seals 128 are located between the outer diameter of tubular section 67 of output coupling 66 and the internal cavity 74 of housing 72. Separation seals are annular seals and are situated on both sides of each of the housing ports 82, 84, 86, 88. Additional bottom seals are located in the output coupling bore 68 at the junction of the tubular section 67 and stem of output coupling 66 and are in sealing engagement with both output coupling 66 and input coupling 60. At the open end of the tubular section 67 of output coupling 66, bearing elements 132 and 134 maintain a coaxial relationship between input coupling 60, output coupling 66 and housing 77. At the closed end of the tubular section bearing element 79 maintains a coaxial relationship between the input coupling 60 and the output coupling 66.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a” “an” and “the” include plural referents, unless the context clearly dictates otherwise. Optional or optionally means that the subsequently described event or circumstances may or may not occur. The description includes instances where the event or circumstance occurs and instances where it does not occur. Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

We claim:

1. An apparatus for assisting in the operation of a gate valve having a linearly movable gate comprising:
a bi-directional hydraulic fluid cylinder having an output rod adopted to be coupled to the gate to move the gate linearly;
a rotary to linear translator connected to an input rod of the cylinder for converting rotary motion to linear movement;
an input coupling and an output coupling coupled to each other and to the translator for providing rotary motion to the translator; and
a rotary valve operatively coupled to the input coupling and adapted to be connected between a hydraulic fluid source and the cylinder so that rotation of the input and output couplings in a first direction causes the translator to linearly move the input and output rods of the cylinder in an opening direction, and rotation of the input coupling in the first direction causes the rotary valve to an open command position directing fluid from the source to the cylinder to provide an assisting force to the input and output rods of the cylinder.

2. The apparatus of claim 1, wherein the input coupling and the output coupling are rotationally moveable relative to each other a fractional amount and the rotation relative to each other causes the rotary valve to move to the open command position.

3. The apparatus of claim 2, further comprising a torsion bar disposed between the input coupling and the output coupling to prevent rotational movement between the input coupling and the output coupling until sufficient torque is applied to the input coupling to cause deformation of the torsion bar.

4. The apparatus of claim 2, further comprising drive dogs mechanically connected between the input coupling and the output coupling that cause rotation in unison after the fractional amount has been reached.

5. The apparatus of claim 2, wherein the input rod comprises external threads on an outer surface, the translator further comprising:
a tubular drive coupling with an internal bore and a central axis, the tubular drive coupling secured to the output coupling;
a travel nut secured within the internal bore of the drive coupling, the travel nut comprising internal threads which engage the external threads of the input rod, so that rotation of the output coupling causes axial movement of the input rod.

6. The apparatus of claim 1, wherein the cylinder has an internal cavity comprising a nut end compartment and a gate end compartment, the apparatus further comprising:
a piston located within the cylinder, the piston secured between the input rod and the output rod and separating the nut end compartment from the gate end compartment, so that a pressure differential between the nut end compartment and the gate end compartment will encourage the gate to move between the open and a closed position;
an open port located in a side wall of the nut end compartment for supplying hydraulic fluid to and from the nut end compartment of the cylinder; and
a close port located in a side wall of the gate end compartment of the cylinder for supplying hydraulic fluid to and from the gate end compartment of the cylinder.

7. The apparatus of claim 2, wherein the rotary valve further comprises:
a sleeve with a central bore;
a cylindrical inner member rotatable within the sleeve to a fractional amount;
an open port and a close port in the sleeve spaced circumferentially apart;
a supply void on the inner member extending circumferentially;
an input port in the sleeve between the open and close ports to supply hydraulic fluid to the supply void.

8. The apparatus of claim 7, wherein rotation of the inner member relative to the sleeve in the first direction provides unequal communication between the open and close ports and the supply void.

9. The apparatus of claim 7, wherein the circumferential extension of the supply void is less than the circumferential distance between the open and close ports.

10. The apparatus of claim 7, wherein rotation of the inner member relative to the sleeve to the fractional amount in the first direction restricts fluid communication between the close port and the supply void and provides fluid communication between the open port and the supply void.

11. The apparatus of claim 7, further comprising:
a return port on the sleeve; and
a return void extending circumferentially on the inner member in fluid communication with the return port, wherein rotation of the inner member relative to the sleeve in the first direction blocks fluid communication between the open port and the return void and provides fluid communication between the close port and the return void.

12. A gate valve comprising:
a gate;
a drive train comprising:
a gate rod for linearly moving the gate;
a translator operatively coupled to the gate rod for moving the gate rod linearly in response to rotational motion; and
a coupling device connected to the translator for providing rotational motion; the gate valve further comprising:
a fluid cylinder cooperatively coupled to the drive train for providing an assisting force to move the gate rod linearly;
a rotary valve cooperatively connected to the coupling device and in a fluid flow path between the cylinder and a fluid pressure source; and
wherein torque applied to the coupling device moves the rotary valve to an open position to supply fluid pressure to the fluid cylinder.

13. The gate valve of claim 12, wherein the coupling device comprises an input coupling and an output coupling rotationally moveable relative to each other a fractional amount so that the rotation relative to each other causes the rotary valve to move to the open command position.

14. The gate valve of claim 13 further comprising a torsion bar disposed between the input coupling and the output coupling to prevent rotational movement between the input coupling and the output coupling until sufficient torque is applied to the input coupling to cause elastic deformation of the torsion bar.

15. The gate valve of claim 13, further comprising drive dogs mechanically connected between the input coupling and the output coupling that cause rotation in unison after the fractional amount has been reached.

16. The gate valve of claim 12, wherein the translator comprises:
a nut rod with external threads on an outer surface;
a tubular drive with an internal bore;
a travel nut secured within the internal bore of the tubular drive, the travel nut comprising internal threads which engage the external threads of the nut rod, so that rotation of the coupling device causes axial movement of the gate rod.

17. The gate valve of claim 12, wherein the cylinder has an internal cavity comprising a nut end compartment and a gate end compartment, the gate valve further comprising:
a piston located within the cylinder, the piston separating the nut end compartment from the gate end compartment, so that a pressure differential between the nut end compartment and the gate end compartment will encourage the gate to move between the open and a closed position;
an open port located in a side wall of the nut end compartment for supplying hydraulic fluid to and from the nut end compartment of the cylinder; and
a close port located in a side wall of the gate end compartment of the cylinder for supplying hydraulic fluid to and from the gate end compartment of the cylinder.

18. The gate valve of claim 12, wherein the rotary valve further comprises:
a sleeve with a central bore;
a cylindrical inner member rotatable within the sleeve to a fractional amount;
an open port and a close port in the sleeve spaced circumferentially apart;
a supply void on the inner member extending circumferentially;
an input port in the sleeve between the open and close ports to supply hydraulic fluid to the supply void.

19. The gate valve of claim 18, wherein rotation of the inner member relative to the sleeve in the first direction provides unequal communication between the open and close ports and the supply void.

20. The gate valve of claim 18, wherein the circumferential extension of the supply void is less than the circumferential distance between the open and close ports.

21. The apparatus of claim 18, wherein rotation of the inner member relative to the sleeve to the fractional amount in the first direction restricts fluid communication between the close port and the supply void and provides fluid communication between the open port and the supply void.

22. The apparatus of claim 18, further comprising:
a return port on the sleeve; and
a return void extending circumferentially on the inner member in fluid communication with the return port, wherein rotation of the inner member relative to the sleeve in the first direction restricts fluid communication between the open port and the return void and provides fluid communication between the close port and the return void.

23. A method for assisting in the operation of a gate valve having a linearly moveable gate comprising the steps of:
(a) coupling a piston rod of a bi-directional hydraulic cylinder to the gate;
(b) connecting a rotary to linear translator to the piston rod;
(c) connecting an input coupling to the translator and providing the input coupling with a rotary valve that is connected between a hydraulic fluid source and the hydraulic cylinder;
(d) rotating the input coupling in a first direction which causes the translator to move the piston rod and gate to an open position; and
(e) the rotation in step (d) also causing the rotary valve to direct fluid from the source to the cylinder to create an open assisting force on the piston rod.

24. The method of claim 23, further comprising the steps of rotating the input coupling in a second direction which causes the translator to move the piston rod and gate to a closed position and the rotary valve to direct fluid from the source to the cylinder to create a close assisting force on the piston rod.

25. The method of claim 23, wherein the rotary valve has open command ports and close command ports, and the step of rotating the input coupling in a first direction communicates the open command port with the source and blocks the close command ports from the source.

26. The method of claim 23, wherein the assisting force provided by the cylinder is proportional to an amount of torque imposed on the input coupling.

27. The method of claim 23, wherein the input coupling has an input portion and an output portion and step (d) initially causes the input portion to rotate a fractional amount relative to the output portion.

28. The method of claim 27, wherein the fractional amount of relative rotation causes rotation of one component of the rotary valve relative to another component of the valve.

29. The method of claim 27, wherein after reaching the fractional amount, continued rotation of the input coupling causes the input portion and output portion to rotate in unison.
